(19) United States
(12) Patent Application Publication
(10) Pub. No.: US 2010/0081327 A1
(43) Pub. Date: Apr. 1, 2010

(54) METHOD AND APPARATUS FOR COMPONENT HANDLING

(76) Inventor: Paul Michael Tusini, Boxford, MA (US)

Correspondence Address: BLANK ROME LLP, WATERGATE, 600 NEW HAMPSHIRE AVENUE, N.W., WASHINGTON, DC, 20037, US

(21) Appl. No.: 12/240,328

(22) Filed: Sep. 29, 2008

(51) Int. Cl. H01R 13/66; H01R 43/16

(52) U.S. Cl. 439/620.21; 29/874

(57) ABSTRACT

A method and apparatus for an adaptor are provided. The adaptor includes a first engaging end including a first connector half configured to mate with a complementary connector half. The first engaging end further includes a first diameter. The adaptor also includes a second engaging end including a second connector half configured to mate with a complementary connector half. The second engaging end further includes a second diameter. The adaptor further includes a body extending between the first engaging end and the second engaging end. The body includes an outer sheath at least partially covering the body and extending at least partially between the first engaging end and the second engaging end wherein the outer sheath includes a third diameter that is greater than at least one of the first and the second diameter.

### BACKGROUND OF THE INVENTION

This invention relates generally to hardware components and, more particularly, to a method and apparatus for improving ease of handling and use of hardware components in a hazardous environment.

At least some known cellular infrastructure installation and repair technicians carry large amounts of tools and electronic test equipment to the tops of antenna towers. The towers may be any height and may be located on or near buildings and other areas where people and property may also be located. To prevent tools and equipment from becoming projectile hazards, tools and equipment may be secured with lanyards to the technician. Such securing may prevent costly loss and damage and injury to people and property below. However, some components such as but not limited to, coaxial adaptors can be heavy, expensive, and are difficult to handle at height even under ideal conditions. Additionally, such components are generally not designed and not possible to secure to the technician's person.

### BRIEF DESCRIPTION OF THE INVENTION

In one embodiment, an adaptor includes a first engaging end including a first connector half configured to mate with a complementary connector half. The first engaging end further includes a first diameter. The adaptor also includes a second engaging end including a second connector half configured to mate with a complementary connector half. The second engaging end further includes a second diameter. The adaptor further includes a body extending between the first engaging end and the second engaging end. The body includes an outer sheath at least partially covering the body and extending at least partially between the first engaging end and the second engaging end wherein the outer sheath includes a third diameter that is greater than at least one of the first and the second diameter.

In another embodiment, a method of forming a coupling adaptor includes providing a coupling adaptor that includes a body having an exterior surface, the body extending between one or more connecting ends. The method also includes forming a sheath of a resilient material, the sheath having an interior cavity substantially complementarily shaped to the body, the sheath including an exterior surface having a texture configured to facilitate increasing a gripability of the adaptor by a user. The method further includes applying the sheath to the body such that the body is substantially surrounded by the sheath between the one or more coupling ends, the sheath extending radially outward from the body.

In yet another embodiment, a coupling adaptor includes a first engaging end including a first connector half. The first connector half is configured to mate with a complementary connector half and includes a first diameter. The coupling adaptor also includes a second engaging end including a second connector half. The second connector half is configured to mate with a complementary connector half and further includes a second diameter. The coupling adaptor further includes a body extending between the first engaging end and the second engaging end and a gripping sheath at least partially covering the body and extending at least partially between the first engaging end and the second engaging end. The gripping sheath is formed of a resilient material.

### BRIEF DESCRIPTION OF THE DRAWINGS

FIGS. 1 and 2 show exemplary embodiments of the method and apparatus described herein.

FIG. 1 is a side schematic view of an adaptor in accordance with an exemplary embodiment of the present invention; and

FIG. 2 is an end view of adaptor 100 (shown in FIG. 1) in accordance with an exemplary embodiment of the present invention.

### DETAILED DESCRIPTION OF THE INVENTION

The following detailed description illustrates embodiments of the invention by way of example and not by way of limitation. It is contemplated that the invention has general application to handholdable components, tools, devices, and equipment in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

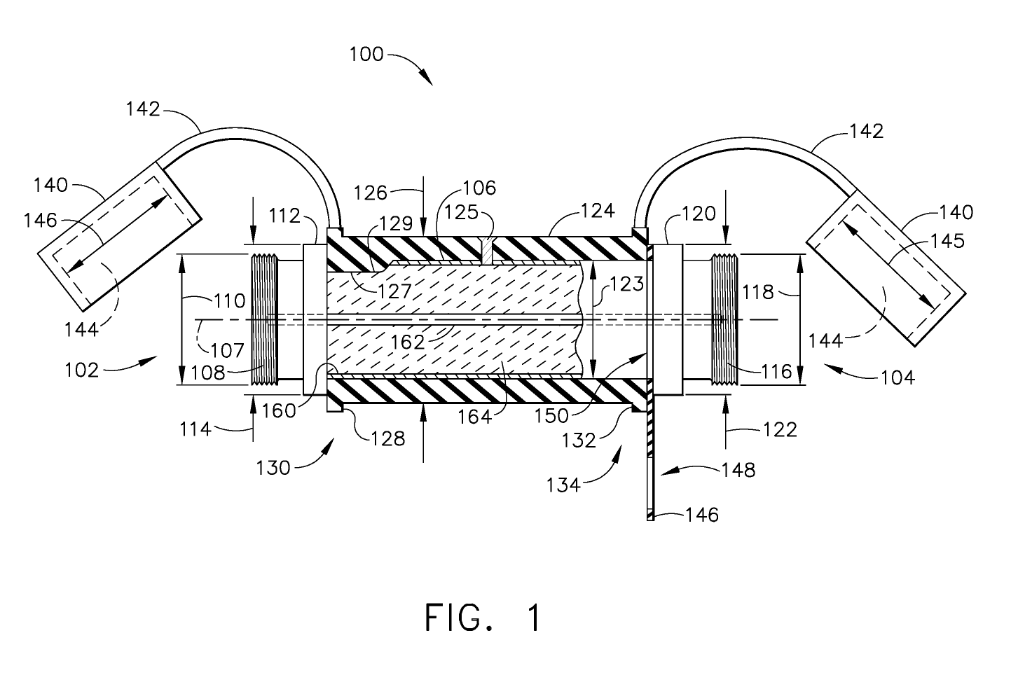

FIG. 1 is a side schematic view of an adaptor 100 in accordance with an exemplary embodiment of the present invention. In the exemplary embodiment, adaptor 100 is an electrical connector designed to work at radio frequencies in the multi-megahertz range. Adaptor 100 is typically used with coaxial cables and is designed to maintain a shielding that the coaxial design offers. Adaptor 100 also facilitates minimizing a change in transmission line impedance at the connection. Mechanically, adaptor 100 provides a fastening mechanism such as but not limited to threads, bayonets, braces, push-pull devices, and springs for a low ohmic electric contact.

In the exemplary embodiment, adaptor 100 includes a first engaging end 102, a second engaging end 104, and a body 106 extending along a longitudinal axis 107 therebetween. First engaging end 102 includes a first connector half 108 configured to mate with a complementary connector half (not shown). First connector half 108 includes a first diameter 110. A collar 112 circumscribes an outer periphery of first engaging end 102 between first connector half 108 and body 106. Collar 112 includes a second diameter 114. In the exemplary embodiment, second diameter 114 is greater than first diameter 110.

In the exemplary embodiment, second engaging end 104 is substantially similar to first engaging end 102, but could be totally different. Second engaging end 104 includes a second connector half 116 configured to mate with a complementary connector half (not shown). Second connector half 116 includes a third diameter 118. A collar 120 circumscribes an outer periphery of second engaging end 104 between second connector half 116 and body 106. Collar 120 includes a fourth diameter 122. In the exemplary embodiment, fourth diameter 122 is greater than third diameter 118.

In the exemplary embodiment, body 106 includes a substantially cylindrical cross-section having a fifth diameter 123 that extends between first engaging end 102 and second engaging end 104. Body 106 includes an outer sheath 124 that at least partially covers body 106 and extends radially outwardly from body 106. Sheath 124 extends axially along body 106 at least partially between first engaging end 102 and second engaging end 104. In the exemplary embodiment, one or more fasteners 125 fix sheath 124 to body 106. In various other embodiments, sheath 124 may be fit over body 106 with a friction fit, an interference fit, or may be formed on body 106 such that a strong adherence bond is formed between sheath 124 and body 106. In various embodiments, body 106 includes a radially outer flat 127 along an outer surface and outer sheath 124 includes a complementary radially inner flat 129 along an inner surface that is sized and spaced axially and circumferentially to engage flat 127. Flats 127 and 129 resist a tendency of sheath 124 to rotate with respect to body 106 during coupling of a cable or device to connector halves 108 and 116. Outer sheath 124 includes an outside sixth diameter 126. In the exemplary embodiment, sheath 124 includes a first shoulder 128 proximate a first end 130 and a second shoulder 132 proximate a second end 134 of sheath 124.

Outer sheath 124 includes an outer surface that in one embodiment, includes a texture such as for example, but not limited to a plurality of protrusions, the texture is configured to facilitate increasing a gripability of adaptor 100 and/or an interference or friction between adaptor 100 and a user's hand for example, a gloved hand. Outer sheath 124 also provides structure for easily and securely gripping the adaptor 100 in a user's hand to resist and thus eliminate or significantly reduce the torque stress induced into cables and/or devices being coupled to adaptor 100 from threading or screwing on and tightening an engaging end of adaptor 100 to the proper torque specifications, which, in some cases is accomplished using a wrench.

In the exemplary embodiment, sheath 124 includes a dust cap 140 coupled to sheath 124 by a lanyard 142. A lanyard 142 and dust cap 140 may be present at only one or both ends of sheath 124. Lanyard 142 and dust cap 140 are formed integrally with sheath 124 for example, by molding sheath 124, dust cap 140, and lanyard together in a mold. In an alternative embodiment, lanyard 142 and dust cap 140 are formed separately form sheath 124 such that lanyard 142 is coupled to sheath 124 and dust cap 140 is coupled to lanyard 142. Lanyards may be separate items and not integrally molded to outer sheath. They may be comprised of ropes or chains of any nature, material and design, and may be affixed to outer sheath or body by screws, clamps or any other affixing mechanism. Protective caps may be made of any material including metal. Caps may be affixed to adaptor connector ends by threads and other means. Dust cap 140 includes a cavity 144 therein. Cavity 144 is configured to receive a respective one of first connector half 108 and second connector half 116 depending on a position of lanyard 142 and dust cap 140 on sheath 124. Accordingly, a diameter 145 of cavity 144 is sized to approximate diameter 110 or diameter 118 such that an interference or friction fit is attained between dust cap 140 and first connector half 108 or second connector half 116. During use, lanyard 142 maintains dust cap 140 available for replacement on first connector half 108 and second connector half 116 when first connector half 108 and second connector half 116 are not coupled to a complementary connector half. In the exemplary embodiment, sheath 124 is fabricated from a resilient material for example, but not limited to rubber, synthetic rubber or other resilient material that that facilitates gripping adaptor 100 by a user with for example, a gloved hand. An eyelet member 146 comprises a relatively thin planar body having a first aperture 148 and a second aperture 150 therethrough. First aperture 148 is configured to receive a clasp (not shown) of a retainer such as a rope, a carabiner, or a hook for securing adaptor 100 to a user's body or other convenient location so adaptor can be prevented from being dropped from a height. Second aperture 150 is sized to fit a diameter 123 of body 106. Aperture 150 permits eyelet member 146 to be secured to body 106. Eyelet member 146 may be affixed and stationary to adaptor or may be able to rotate partially or completely around adaptor.

In the exemplary embodiment, adaptor 100 includes a substantially cylindrical bore 160 therethrough. One more conductors 162 extend axially through bore 160 from first engaging end 102 to second engaging end 104. The one or more conductors 162 are typically arranged coaxially within bore 160, however, conductors 162 may be arranged in any configuration. Bore 160 also includes an insulation material 164 that is used to electrically isolate each of the one or more conductors 162 from each other and from body 106. Insulation material 164 may also comprise properties that facilitate maintaining conductors 162 a distance apart to prevent chafing and limit leakage or moisture intrusion through bore 160 and prevent electrical shorting.

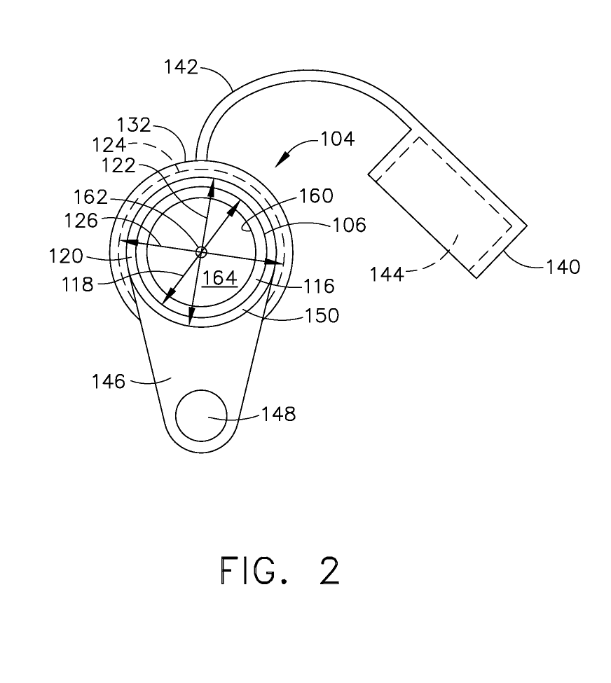

FIG. 2 is an end view of adaptor 100 (shown in FIG. 1) in accordance with an exemplary embodiment of the present invention. In the exemplary embodiment, adaptor 100 includes at second engaging end 104, bore 160 and one more conductors 162 extending axially through bore 160. Bore 160 also includes insulation material 164 surrounding conductors 162 and substantially filling bore 160. Second engaging end 104 includes second connector half 116 comprising a fastening mechanism such as but not limited to threads, bayonets, braces, push-pull devices, and springs for a low ohmic electric contact between conductors 162 and complementary conductors in a mating connector (not shown). Second connector half 116 includes a third diameter 118. A collar 120 circumscribes an outer periphery of second engaging end 104. Collar 120 includes a fourth diameter 122. In the exemplary embodiment, fourth diameter 122 is greater than third diameter 118.

Body 106 includes outer sheath 124 that includes outside sixth diameter 126. In the exemplary embodiment, sheath 124 includes second shoulder 132.

In the exemplary embodiment, sheath 124 includes dust cap 140 coupled to sheath 124 by lanyard 142. Dust cap 140 includes a cavity 144. An eyelet member 146 comprises a relatively thin planar body having first aperture 148 and second aperture 150 therethrough. First aperture 148 is configured to receive a clasp (not shown) of a retainer such as a rope, a carabiner, or a hook for securing adaptor 100 to a user's body or other convenient location so adaptor can be prevented from being dropped from a height. Second aperture 150 is sized to fit diameter 123 of body 106. Aperture 150 permits eyelet member 146 to be secured to body 106.

The above-described embodiments of a method and apparatus of forming a coupling adaptor provide a cost-effective and reliable means providing a handholdable component. More specifically, the method and apparatus described herein facilitate manually securing and manipulating components that may otherwise be unwieldy in adverse environments such as encountered while working at elevated locations on towers in a variety of weather conditions. In addition, the above-described methods and apparatus facilitate securing the component to a user's person to reduce the possibility of the component becoming a missile hazard if dropped. As a result, the method and apparatus described herein facilitate performing maintenance and testing in adverse environments in a cost-effective and reliable manner.

While the disclosure has been described in terms of various specific embodiments, it will be recognized that the disclosure can be practiced with modification within the spirit and scope of the claims.

What is claimed is:

1. An adaptor comprising:
a first engaging end comprising a first connector half, said first connector half configured to mate with a complementary connector half, said first engaging end further comprising a first diameter;
a second engaging end comprising a second connector half, said second connector half configured to mate with a complementary connector half, said second engaging end further comprising a second diameter; and
a body extending between said first engaging end and said second engaging end, said body comprising an outer sheath at least partially covering said body and extending at least partially between said first engaging end and said second engaging end, said outer sheath comprising a third diameter, the third diameter being greater than at least one of the first and the second diameter.

2. An adaptor in accordance with claim 1 wherein said outer sheath comprises a resilient material.

3. An adaptor in accordance with claim 1 wherein said body comprises a first flat along a radially outer surface and said outer sheath comprises a second flat along a radially inner surface.

4. An adaptor in accordance with claim 1 further comprising an end cap configured to engage at least one of said first and said second engaging ends such that the at least one of said first and said second engaging ends are at least partially sealed from an environment external to said at least one of said first and said second engaging ends.

5. An adaptor in accordance with claim 4 wherein said outer sheath comprises a lanyard extending between said end cap and said outer sheath.

6. An adaptor in accordance with claim 5 wherein said outer sheath, said end cap and said lanyard are integrally formed.

7. An adaptor in accordance with claim 4 wherein said body comprises a lanyard extending between said end cap and said body.

8. An adaptor in accordance with claim 1 wherein said body comprises an eyelet member, said eyelet member coupled to said adaptor, said eyelet member comprising an aperture for securing adaptor to a retainer.

9. A method of forming a coupling adaptor, said method comprising:
providing a coupling adaptor that includes a body having an exterior surface, the body extending between one or more connecting ends;
forming a sheath of a resilient material, the sheath having an interior cavity substantially complementarily shaped to the body, the sheath including an exterior surface having a texture configured to facilitate increasing a gripability of the adaptor by a user; and
applying the sheath to the body such that the body is substantially surrounded by the sheath between the one or more coupling ends, the sheath extending radially outward from the body.

10. A method in accordance with claim 9 wherein forming a sheath of a resilient material comprises forming a end cap integrally with the sheath, the end cap sized to couple to a respective connecting end.

11. A method in accordance with claim 9 wherein forming a sheath of a resilient material comprises forming a lanyard integrally with the sheath.

12. A method in accordance with claim 9 further comprising fastening the sheath to the body using a fastener extending through the sheath into the body.

13. A method in accordance with claim 9 wherein applying the sheath to the body comprises:
molding a non-solid resilient material over the body; and
curing the resilient material to form a solid resilient sheath about an external surface of the body.

14. A method in accordance with claim 9 wherein applying the sheath to the body comprises adhering the sheath to the body using an adhesive material.

15. A method in accordance with claim 9 further comprising coupling an eyelet member to the body, the eyelet member comprising an aperture configured to receive a retaining device.

16. A coupling adaptor comprising:
a first engaging end comprising a first connector half, said first connector half configured to mate with a complementary connector half, said first engaging end further comprising a first diameter;
a second engaging end comprising a second connector half, said second connector half configured to mate with a complementary connector half, said second engaging end further comprising a second diameter;
a body extending between said first engaging end and said second engaging end; and
a gripping sheath at least partially covering said body and extending at least partially between said first engaging end and said second engaging end, said gripping sheath formed of a resilient material.

17. A coupling adaptor in accordance with claim 16 wherein said gripping sheath comprises a third diameter, the third diameter being greater than at least one of the first and the second diameter.

18. A coupling adaptor in accordance with claim 16 further comprising an end cap and a lanyard integrally formed with said gripping sheath, said end cap configured to engage at least one of said first and said second engaging ends such that the at least one of said first and said second engaging ends are at least partially sealed from an environment external to said at least one of said first and said second engaging ends, said lanyard extending between said end cap and said outer sheath.

19. A coupling adaptor in accordance with claim 16 wherein said body comprises a lanyard extending between an end cap and said body.

20. A coupling adaptor in accordance with claim 16 wherein said body comprises an eyelet member, said eyelet member coupled to said adaptor, said eyelet member comprising an aperture for securing adaptor to a retainer.
